(19) United States
(12) Patent Application Publication
(10) Pub. No.: US 2024/0430870 A1
(43) Pub. Date: Dec. 26, 2024

(54) WIRELESS LOCAL AREA NETWORK (LAN) CARRIER FREQUENCY CORRECTION FOR UPLINK TRANSMISSION

(71) Applicant: Cypress Semiconductor Corporation, San Jose, CA (US)

(72) Inventors: Amit Shaw, Bangalore (IN); Nutan Reddy ANNAPU REDDY, Hyderabad (IN)

(73) Assignee: Cypress Semiconductor Corporation, San Jose, CA (US)

(21) Appl. No.: 18/338,674

(22) Filed: Jun. 21, 2023

(51) Int. Cl. H04W 72/0453; H04W 74/08

(52) U.S. Cl. CPC H04W 72/0453; H04W 74/08; H04W 84/12

(57) ABSTRACT

A method includes receiving a plurality of frames from an access point. The method further includes determining a carrier frequency offset (CFO) estimate for each of the plurality of frames received from the access point. The method further includes computing a final CFO estimate based on the CFO estimates. The method further includes changing, based on the final CFO estimate, a first phase of a radio frequency phase-locked loop (RF PLL) to a second phase.

### TECHNICAL FIELD

This disclosure relates to wireless devices and, more specifically, to wireless local area network (LAN) carrier frequency correction for uplink transmission.

### BACKGROUND

Wireless local area network (LAN) technology has evolved to the point that wireless devices can communicate with very high throughput, high efficiency, and support both multi-user (MU) orthogonal frequency division multiple access (OFDMA) and multi-user multiple-input and multiple output (MU-MIMO) in both the downlink and the uplink directions. Because an access point (AP) or base station (BS) in uplink transmissions under these Wi-Fi 6 technologies requires stringent levels of timing synchronization, power control for a target receive power, and a high signal quality from multiple transmission devices, support for MU OFDMA and MU-MIMO in the uplink direction has put stringent requirements (compared to legacy methods) also on transmission devices. These stringent Wi-Fi 6 requirements include those related to in-band distortions, e.g., error vector magnitude (EVM), and out-band distortions, e.g., unused tone error (UTE) and carrier frequency offset (CFO) with respect to the AP/BS. This, in turn, puts stringent requirements on transmitter CFO and carrier leakage within the AP/BS from trigger-based physical layer protocol data unit (TB-PPDU) frames received from the transmission devices. While the standard associated with Wi-Fi 6 states that transmission devices have to pre-correct for in-band and out-of-band distortions to meet these stringent standard levels for EVM, UTE, and CFO, the standard does not teach how this is to be done practically by such transmission devices.

### BRIEF DESCRIPTION OF THE DRAWINGS

FIG. 1 is a block diagram of an exemplary wireless communication system, according to some embodiments.

FIG. 2 is a simplified timing diagram illustrating a wireless device (station) using wireless LAN carrier frequency correction for an uplink transmission, according to some embodiments.

FIG. 3 is a flow diagram of a method of performing wireless LAN carrier frequency correction for uplink transmission, according to some embodiments.

FIG. 4 is a timing diagram illustrating radio frequency (RF) phased-locked loop (PLL) re-tune triggering for wireless LAN carrier frequency correction for uplink transmission, according to some embodiments.

FIG. 5A is a flow diagram of a method of performing wireless LAN carrier frequency correction for uplink transmission, according to some embodiments.

FIG. 5B is a flow diagram of a method of performing RF PLL retuning for wireless LAN carrier frequency correction for uplink transmission, according to some embodiments.

FIG. 6 is a block diagram of a wireless device to perform frequency estimation and trigger LO trim (RF PLL retuning) for wireless LAN carrier frequency correction for uplink transmission, according to some embodiments.

FIG. 7 is a block diagram of a wireless device employing hardware to perform frequency estimation and trigger LO trim (RF PLL retuning) for wireless LAN carrier frequency correction for uplink transmission, according to some embodiments.

FIG. 8 is a block diagram of a wireless device employing hardware to perform both LO trim pre-correction RF PLL retuning and analog front end (AFE) PLL trimming for wireless LAN carrier frequency correction for uplink transmission, according to some embodiments.

FIG. 9 is a block diagram of a wireless device 900 that performs LO trim (RF PLL retuning) for coarse carrier frequency correction and digital pre-correction for fine carrier frequency for wireless LAN carrier frequency correction for uplink transmission, according to various embodiments.

FIG. 10 is a flow diagram of a method 1000 of performing LO trim (RF PLL retuning) pre-correction for coarse carrier frequency correction and digital pre-correction for fine carrier frequency correction for wireless LAN carrier frequency correction for uplink transmission, according to various embodiments.

FIG. 11 is a flow diagram of a method of performing wireless LAN carrier frequency correction for uplink transmission, according to some embodiments.

FIG. 12 is a simplified timing diagram illustrating LO trim triggering for wireless LAN carrier frequency correction for uplink transmission, according to some embodiments.

### DETAILED DESCRIPTION

The following description sets forth numerous specific details, such as examples of specific systems, devices, components, methods, and so forth, in order to provide a good understanding of various embodiments of wireless local area network (LAN) carrier frequency correction for uplink transmission. Wireless LAN devices have evolved over generations. For example, the first two generations of the Wi-Fi® standard were based on the single carrier spread spectrum technique, while later generations adopted a more efficient orthogonal frequency-division multiplexing (OFDM) as the basic modulation technique. Still, later generations added support for multiple antenna technology, e.g., multiple-input multiple-output (MIMO), to enhance reliability and throughput using spatial dimensions such as redundancy and multiplexing. However, the access mechanism has been using carrier sense multiple access with collision avoidance (CSMA/CA) and a random back-off as the access mechanism to share a medium or channel across users. This meant only a single user (SU) can use the medium or channel at any time instance.

Still more recent Institute of Electrical and Electronics Engineers (IEEE) 802.11ac standard, also referred to as very high throughput (VHT) or Wi-Fi® 5, added support for multi-user (MU) capability in the downlink direction using MU-MIMO technique. This has allowed multiple users to share the medium at one time instance, e.g., by being multiplexed together. Most recently, the IEEE 802.11ax standard, also referred to as high efficiency (HE) or Wi-Fi® 6, added multi-user (MU) support in both uplink and downlink directions using orthogonal frequency division multiple access (OFDMA) and MU-MIMO techniques. For these most recent standards, on the downlink side, an access point (AP) or base station (BS) frame synchronization is a default, point-to-multi-point transmission, e.g., because the AP/BS is just sending content to individual wireless devices as the content is received generally by multiplexing various content to the correct wireless device. On the uplink side, in contrast, the AP/BS is configured to receive transmissions from multiple wireless devices (multi-point-to-point) so that the AP/BS receives the content correctly when concurrently receiving multiple streams from multiple devices that are to then be transmitted. This requires synchronization among the multiple wireless devices.

As was mentioned, stringent Wi-Fi® 6 requirements for uplink transmission include those related to in-band distortions, e.g., error vector magnitude (EVM), and out-band distortions, e.g., unused tone error (UTE) and carrier frequency offset (CFO) with respect to the AP/BS. This, in turn, puts stringent requirements on timing and well as carrier leakage within the access point from the trigger-based physical layer protocol data unit (TB-PPDU) frames received from the transmission devices. While the standard associated with Wi-Fi® 6 states that transmission devices have to pre-correct for in-band and out-of-band distortions to meet these stringent standard levels for EVM, UTE, and CFO, the Wi-Fi® 6 standard does not teach how this is to be done practically by transmission devices. As discussed in more detail below, while current digital pre-correction techniques improve (e.g., decrease) carrier leakage, they do not do so to the level now required under the most recent Wi-Fi® standards.

To resolve these and other deficiencies with known approaches to carrier leakage reduction, the present disclosure sets forth configuring and/or operating wireless devices to instead (or in addition to performing digital pre-correction) perform a carrier frequency correction for uplink transmission. By determining carrier frequency offset (CFO) estimates for frames received by a wireless device, a statistical measure (e.g., an average, weighted average, moving average, mean, etc.) can be computed using the CFO estimates and an RF PLL of the device can be re-tuned according to the computed statistical measure, enabling its carrier frequencies to undergo larger frequency adjustments and better meet the stringent standard levels for EVM, UTE, and CFO.

Thus, in at least some embodiments, a method includes receiving frames from an access point. The method further includes determining a CFO estimate for each of the frames received from the access point. The method further includes computing a final CFO estimate based on the CFO estimates. The method further includes changing, based on the final CFO estimate, a first phase of an RF PLL to a second phase.

In some embodiments, an apparatus is disclosed that employs an RF PLL to receive frames from an access point while the RF PLL operates a first phase. A processing device (e.g., state machine, firmware, etc.) is coupled to the RF PLL and determines a CFO estimate for each frame received from the access point. The processing device computes a final CFO estimate (e.g., an average, weighted average, moving average, or mean of the received CFO estimates) and changes the RF PLL from the first phase to a second phase based on the final CFO estimate.

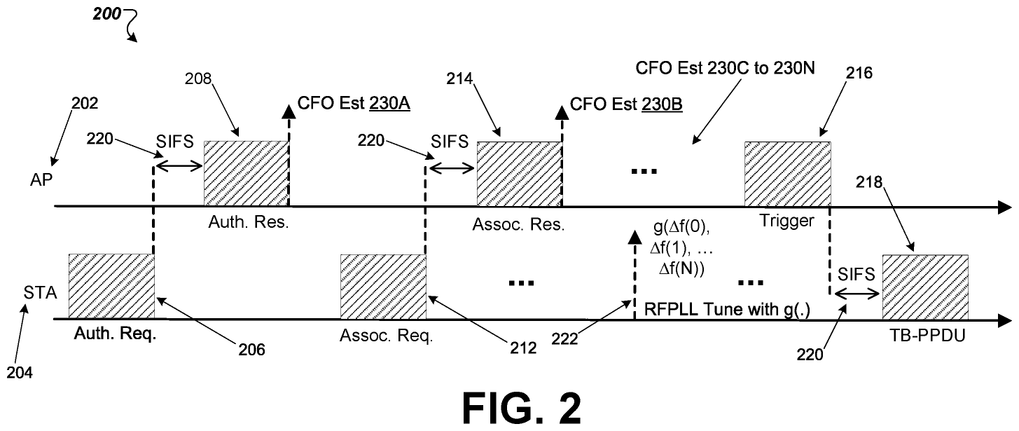

In some embodiments, a system that employs a first circuit to receive frames from an access point is disclosed. The first circuit includes an RF PLL. The system further employs a second circuit (e.g., state machine, firmware, etc.) to determine a CFO estimate for each frame received from the access point. The second circuit computes a final CFO estimate (e.g., an average, weighted average, moving average, or mean of the received CFO estimates) and changes the RF PLL from the first phase to a second phase based on the final CFO estimate. Additional embodiments and variations in implementation will be discussed in detail with reference to FIGS. 2-14.

The present disclosure includes a number of advantages, including the ability to take care of carrier frequency offset (CFO) by changing the frequency at which radio circuitry (e.g., an RF PLL) operates (e.g., RF PLL retuning) based on a final CFO estimate determined by computing a statistical measure (e.g., an average, weighted average, moving average, or mean) of received CFO estimates. In this way, the issue of stringent carrier leakage can be minimized. This approach also relaxes requirements on residual carrier leakage to meet UTE requirements. This approach also avoids correcting CFO in a time-critical manner and does not require stringent timing. Wireless LAN carrier frequency correction for uplink transmission using RF PLL retuning enables a wider range of potential frequency modifications to at least meet the stringent standard levels for EVM, UTE, and CFO. This approach can relax the transmit carrier leakage specification by more than 20 dB. In other words, under similar transmit carrier leakage, the proposed approach will provide more than 20 dB more margin in terms of UTE compared to conventional solutions. Additional advantages will be apparent to those skilled in the art of modern wireless technologies and recent IEEE standards.

Although the present disclosure describes some embodiments for wireless LAN carrier frequency correction for multi-user uplink transmission, in some embodiments, wireless LAN carrier frequency correction for uplink transmission may be single-user (SU) uplink transmissions. Such use in SU transmissions helps the corresponding receiver improve sensitivity because of a smaller residual frequency offset that the receiver needs to estimate and compensate for at the receiver side. Further, although the present disclosure describes wireless LAN carrier frequency correction for uplink transmission, in some embodiments, carrier frequency correction for uplink transmission may be performed for any type of personal area network (e.g., Bluetooth®, Zigbee, Near Field Communication, etc.).

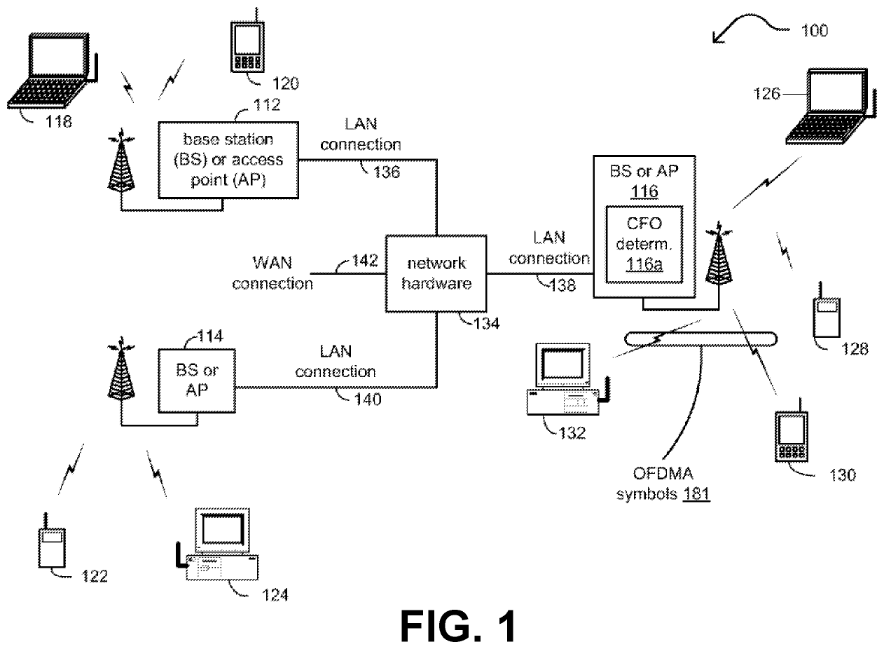

FIG. 1 is a block diagram of an exemplary wireless communication system 100 according to some embodiments. In these embodiments, the wireless communication system 100 includes base stations and/or access points 112-116 (which can be referred to interchangeably herein), wireless devices 118-132 (e.g., wireless stations (STAs) and other such wireless communication devices), and a network hardware component 134. The wireless devices 118-132 may be include laptop computers 118 or tablets 126, personal digital assistants 120 and 130, personal computers 124 and 132, and/or cellular telephones 122 and 128. The details of an embodiment of such wireless devices when acting as transmission devices are described in greater detail hereinafter.

In embodiments, the base stations (BSs) or access points (APs) 112-116 are operably coupled to the network hardware component 134 via local area network connections 136, 138, and 140. The network hardware component 134, which may be a router, switch, bridge, modem, system controller, etc., provides a wide area network connection 142 for the communication system 100. Each of the base stations or access points 112-116 has an associated antenna or antenna array to communicate with the wireless communication devices in an area reachable by each respective base station or access point. Typically, the wireless devices register with a particular base station or access point 112-116 to receive services from the communication system 100. For direct connections (i.e., point-to-point communications), wireless communication devices communicate directly via an allocated channel.

Any of the various wireless devices 118-132 and BSs or APs 112-116 may include a processor and a communication interface to support communications with any other of the wireless devices 118-132 and BSs or APs 112-116. In an example of operation, a processor and the communication interface implemented within one of the devices (e.g., any one of the wireless devices 118-132 and BSs or APs 112-116) are configured to process at least one signal received from and/or to generate at least one signal to be transmitted to another one of the devices (e.g., any other one of the wireless devices 118-132 and BSs or APs 112-116).

Note that general reference to a communication device, such as a wireless device (e.g., wireless devices) 118-132 and BSs or APs 112-116 in FIG. 1, or any other communication devices and/or wireless communication devices may alternatively be made generally herein using the term ‘device’ for brevity. The processor and the communication interface of any one of the various devices, wireless devices 118-132 and BSs or APs 112-116, may be configured to support communications with any other of the various devices, wireless devices 118-132 and BSs or APs 112-116. Such communications may be unidirectional or bidirectional between devices. Also, such communications may be unidirectional between devices at one time and bidirectional between those devices at another time, although the embodiments herein are generally focused on wireless devices transmitting to a BS or AP 112-116 operating in a multi-user transmission mode such as MU OFDMA or MU-MIMO.

In an example of operation, the AP/BS device 116 (representative of any of the BS or AP 112-116) includes a communication interface and a processor configured to receive one or more signals (e.g., OFDMA symbols 181) from devices 130 and 132. Considering an OFDMA example, device 130 uses a first at least one sub-carrier, and device 132 uses a second at least one sub-carrier. Generally, different subsets of sub-carriers are assigned for use by different devices. Such assignments may be dynamic, adaptive, etc., for different devices for different symbols and/or at different times.

In these embodiments, the AP/BS device 116 receives a first OFDMA symbol that includes first data from the device 130 modulated on a first set of at least one sub-carrier and second data from the device 132 modulated on a second set of at least one sub-carrier. The AP/BS device 116 processes the first data to decode (or demodulate) the data from the first device 130. The AP/BS device 116 also processes the second data to decode (or demodulate) the data from the second device 132. In other instance/embodiments, the AP/BS device 116 receives a first MU-MIMO symbol that includes first data from the device 130 modulated on a first set of at least one sub-carrier and second data from the device 132 modulated on a first set of at least one sub-carrier. The AP/BS device 116 spatially processes the first data to decode (or demodulate) the data from the first device 130. The AP/BS device 116 also spatially processes the second data to decode (or demodulate) the data from the second device 132. In both instances, first device 130 and second device 132 send data with the precorrected CFO that the first and second devices 130 and 132 estimate based on the trigger frame that precedes the data frame. Such capability within first and second devices 130 and 132 may generally be referred to as CFO precorrection capability. With respect to this embodiment and other embodiments or examples provided herein, there may be instances in which the precorrected CFO results in a zero offset between the AP/BS device 116 and another device similar to devices 130 and 132 (e.g. devices 126 or 128).

Generally, the AP/BS device 116 operates by processing data from another device that is included within the same set of at least one sub-carrier. A number of different combinations of such data and copies and/or repeats of that data may be used in various embodiments. When the other device precorrects the CFO the other device, similar to devices 130 and 132 above, modifies or adapts communications to and/or from that device to compensate for any CFO that may exist between the AP/BS device 116 and the other device to ensure effective communications, synchronization, and improved performance of the communications between the devices.

FIG. 2 is a simplified timing diagram 200 illustrating a wireless device (station) using wireless LAN carrier frequency correction for an uplink transmission, according to some embodiments.

In some embodiments, the station device 204 sends an authentication request frame 206 to the AP/BS device 202. In some embodiments, authentication request frames (e.g., authentication request frame 206) are a type of management frame used in Wi-Fi® networks. An authentication request frame may be sent by a station device (e.g., station device 204) to initiate the process of authenticating with an access point.

The AP/BS 202, following a short interframe space (SIFS) 220, sends an authentication response frame 208 to station device 204. In some embodiments, an authentication response frame (e.g., authentication response frame 208) may be a type of management frame used in Wi-Fi® networks. An authentication response frame may be sent by an access point (e.g., AP/BS 202) in response to an authentication request frame sent by a station (e.g., station device 204). An authentication response frame is sent in response to an authentication request frame and may contain information about the authentication method used by the network (e.g., Wi-Fi Protected Access Pre-Shared Key (WPA2-PSK), WPA2-Enterprise, etc.).

In some embodiments, a SIFS (e.g., SIFS 220) is 16 microseconds (μs)+/−400 ns after the end of the preceding frame as mandated by the IEEE 802.11ax standard. This SIFS time period could change in the future, so the precise amount of time is not critical, but it is instructive to see that it is a very short time interval that is not expected to vary.

The station device 204 then sends an association request frame 212 to the AP/BS device 202. In some embodiments, an association request frame may be a type of management frame used in Wi-Fi® networks. An association request frame (e.g., association request frame 212) may be sent by a station (e.g., station device 204) to request association with an access point (e.g., AP 202) and to initiate the process of connecting to the network.

The AP/BS 202, following a short interframe space (SIFS) 220, sends an association response frame 214 to station device 204. In some embodiments, an association response frame (e.g., an association response frame 214) may be a type of management frame used in Wi-Fi® networks. An association response frame may be sent by an access point (e.g., AP/BS 202) in response to an association request frame (e.g., association request frame 212) sent by a station (e.g., station device 204) and contains information about whether the association was successful or not, as well as additional information about the network.

In some embodiments, the frame sent and received between station device 204 and AP/BS 202 may be management frames (e.g., beacon frames, probe request frames, probe response frames, association request frames, association response frames, authentication frames, de-authentication frames, etc.) In some embodiments, the frame sent and received between station device 204 and AP/BS 202 may be control frames (e.g., request to send (RTS) frames, clear to send (CTS) frames, acknowledgment (ACK) frames, etc.). In some embodiments, the frame sent and received between station device 204 and AP/BS 202 may be data frames (e.g., data frames, null function frames, etc.). In some embodiments, each frame sent by the AP/BS (e.g., AP/BS 202) will have a CFO, and the station receiving such frames (e.g., station device 204) will determine a CFO estimate for each frame received from the AP/BS.

In some embodiments, station device 204 and AP/BS 202 continue to send and receive frames (e.g., up to N frames). Each frame sent by the AP/BS (e.g., AP/BS 202) will have a CFO, and the station receiving such frames (e.g., station device 204) will determine a CFO estimate for each frame received from the AP/BS (e.g., CFOs estimates 230A-N). In some embodiments, the CFO estimates may have a small magnitude. In some embodiments, the CFO estimates may have a large magnitude.

In some embodiments, an RF PLL tune 222 (e.g., re-tune) may be triggered. In some embodiments, a function (e.g., g(.)) receives inputs (e.g., CFO estimates 230A-N) and outputs a final CFO estimate based on the inputs (e.g., CFO estimates used as inputs). In some embodiments, computing the final CFO estimate may include calculating a statistical metric (e.g., an average, weighted average, moving average, mean, and/or the like) of the CFO estimates. In some embodiments, a function g(.) receives CFO estimates as input and outputs the final CFO estimates. In some embodiments, function g(.) may employ any number of statistical or mathematical techniques to produce the output (e.g., final CFO estimate).

In some embodiments, the phase of an RF PLL is changed based on the final CFO estimate. In some embodiments, the final CFO estimate is a frequency, and the phase of the RF PLL may be changed by trimming a LO that is a part of the RF PLL. For example, for a final CFO estimate of 1 MHz, a LO would be adjusted by 1 MHZ in an LO trim to re-tune the RF PLL.

In some embodiments, an RF PLL re-tuning operation includes changing the RF PLL from a first phase to a second phase based on the final CFO estimate. In some embodiments, an RF PLL re-tuning operation does not require stringent timing because the medium may be reserved to perform the RF PLL re-tuning operation, and the RF PLL re-tuning operation does not need to be completed within a short period of time (e.g., a few microseconds). In some embodiments, once the RF PLL retuning settles, communication (e.g., between station device 204 and AP/BS 202) may be resumed.

In some embodiments, station device 204 determines if the final CFO estimate meets a criterion before changing the RF PLL from a first phase to a second phase (i.e., tuning/retuning the RF PLL). In some embodiments, the criterion may be a determination that a number of CFO estimates equals a threshold number of CFO estimates. For example, in some embodiments, the RF PLL re-tuning operation may not be triggered until the number of CFO estimates is greater than a threshold value. In some embodiments, the threshold number of CFO estimates is based on the magnitudes of the CFO estimates. For example, in some embodiments, the RF PLL re-tuning operation may not be triggered until the magnitudes of the CFO estimates is greater than 1 MHZ. In some embodiments, station device 204 may determine a magnitude of at least one of the CFO estimates and change the threshold number of CFO estimates from a first number to a second number responsive to the magnitude of the at least one of the CFO estimates meeting a threshold magnitude. For example, in some embodiments, if the magnitude of the first three CFO estimates is greater than a threshold magnitude (e.g., a certain number of Hz), then the threshold number of CFO estimates needed to compute a final CFO estimate may be changed from a first number to a second number (e.g., sixteen to two). In some embodiments, because the magnitude of CFO estimates is relatively large, a final CFO estimate may need to be calculated sooner to facilitate a correction of the relatively large CFO that may cause transmission difficulties (e.g., carrier leakage and/or the like).

In some embodiments, the final CFO estimate may not meet the criterion, and station device 204 will not change the first phase of the RF PLL to a second phase (i.e., perform an RF PLL re-tuning operation based on the final CFO estimate). In some embodiments, station device 204 may receive an additional frame from the AP/BS 202 and determine a CFO estimate for the additional frame received from the AP/BS 202. Station device 204 may then compute an updated final CFO estimate based on the CFO estimate. In some embodiments, computing an updated final CFO estimate based on the CFO estimate may include re-computing the final CFO estimate using the CFO estimates and the CFO estimate. In some embodiments, computing an updated final CFO estimate based on the CFO estimate may include re-computing the final CFO estimate using a subset of the CFO estimates and the CFO estimate. In some embodiments, computing an updated final CFO estimate based on the CFO estimate may include re-computing the final CFO estimate using only the CFO estimate.

In some embodiments, station device 204 may determine whether the updated final CFO estimate meets a criterion and change the first phase of the RF PLL to the second phase based on the final CFO estimate meeting the criterion. In some embodiments, the station device 204 may continue to receive additional frames from the access point based on the final CFO estimate not meeting the criterion.

In some embodiments, AP/BS 202 may send a trigger frame to station device 204. Station device 204, following SIFS 220 sends a TB-PPDU frame 218 to AP/BS 202.

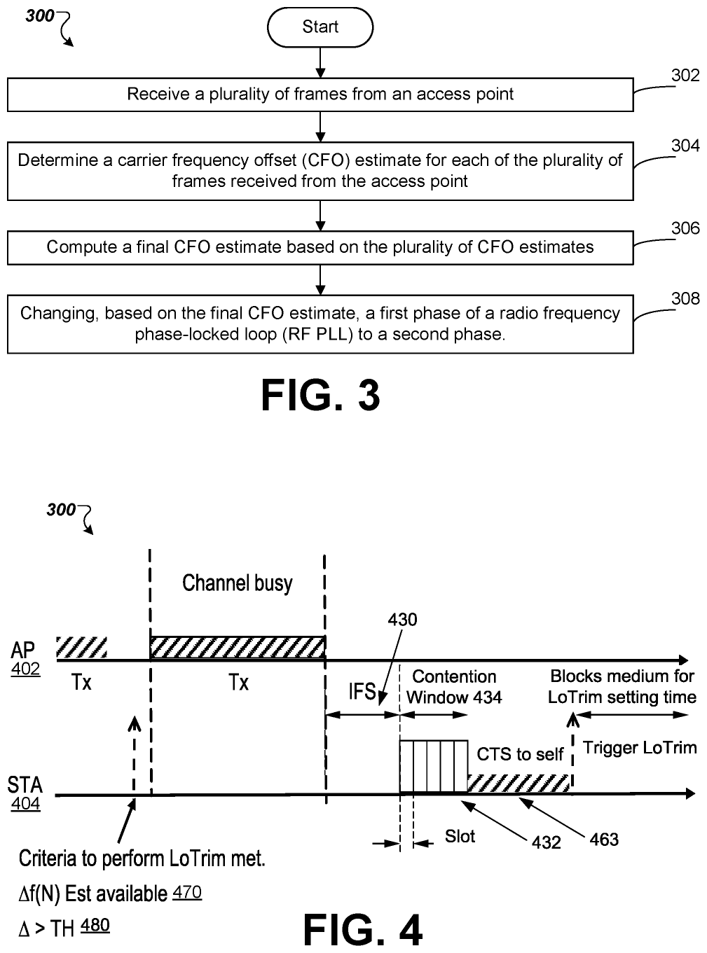

FIG. 3 is a flow diagram of a method of performing wireless LAN carrier frequency correction for uplink transmission, according to some embodiments.

The method 300 may be performed by processing logic that comprises hardware (e.g., circuitry, dedicated logic, programmable logic, microcode, etc.), software (such as instructions run on a processing device), or a combination thereof. The method 300 may be performed wholly or partially by any of wireless devices 118-132 or station device 204, or components thereof. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

Method 300 begins at block 302, where processing logic performing the method receives a plurality of frames from an access point. In some embodiments, the plurality of frames may be at least one of management frames, control frames, or data frames.

At block 304, the processing logic determines a CFO estimate for each of the plurality of frames received from the access point. In some embodiments, a CFO estimate is the difference between a carrier frequency at the transmitter and a carrier frequency at the receiver.

In some embodiments, the processing logic further determines whether the final CFO estimate meets a criterion. In some embodiments, the criterion may be that the final CFO estimate must meet or exceed a threshold magnitude (e.g., the final CFO estimate must be greater than 5 MHZ).

In some embodiments, the changing the first phase of the RF PLL to the second phase may be based on the final CFO estimate meeting the criterion.

In some embodiments, meeting the criterion may include determining that a number of CFO estimates equals a threshold number of CFO estimates. In some embodiments, the criterion may be a threshold number of CFO estimates corresponding to a number of received frames. For example, the final CFO estimate does not meet the criterion if computed using less than two CFO estimates.

In some embodiments, the processing logic further determines a magnitude of at least one of the CFO estimates. In some embodiments, the processing logic changes the threshold number of CFO estimates from a first number to a second number responsive to the magnitude of the at least one of the CFO estimates meeting a threshold magnitude. In some embodiments, the threshold number of CFO estimates is based on the magnitudes of the CFO estimates. For example, a final CFO estimate may not be calculated under normal conditions until eight CFO estimates have been received. However, if the magnitude of one or more of a number of received estimates meets a threshold magnitude value (e.g., two of three received estimates are greater than the threshold magnitude value), then the final CFO estimate is calculated using only three CFO estimates.

At block 306, the processing logic computes a final CFO estimate based on the plurality of CFO estimates.

In some embodiments, the computing the final CFO estimate based on the CFO estimates includes calculating at least one of an average, weighted average, moving average, or mean. In some embodiments, a function, for example (g(.)), is used to compute the final CFO estimate. In some embodiments, function (g(.)) may process the previous N CFO estimates to compute a final CFO estimate used for LO-trim. In some embodiments, the output of (g(.)) can be an average of the last N estimates to help improve the accuracy of the CFO estimates.

In some embodiments, such an average may be expressed by: Δ=(Δf(0)+Δf(1)+ . . . . Δf(N))/N. In some embodiments, the output of (g(.)) can be a weighted average of the last N CFO estimates. In some embodiments, such a weighted average may be expressed by: Δ=(w0*Δf(0)+w1*Δf(1)+ . . . +wN*Δf(N))/N. Using such a weighted average calculation, the weights w0, w1, . . . , wN can be selected based on fixed values with more weight to current estimates than past estimates (e.g., wk=c (−a.t(k))/Σe (−a.t(k))). In some embodiments, the weights w0, w1, . . . , wN can be selected based on an estimated signal-to-noise ratio (SNR) of the frames corresponding to the frequency estimates (e.g., wk=e(−SNRk)/Σe(−SNRk)).

In some embodiments, the averaging window size (N number of CFO estimates) can be chosen based on a moving average estimate of the frequency offset (e.g., (MA(Δf(i))>THRESH)→N=Nₛₘₐₗₗ, otherwise N_{large}. In some embodiments, the averaging window size can also be chosen with a more granular N based on an array of thresholds.

At block 308, the processing logic changes from a first phase of an RF PLL to a second phase based on the final CFO estimate. In some embodiments, changing the first phase of the RF PLL to a second phase is known as an RF PLL re-tuning operation. In some embodiments, an RF PLL re-tuning operation is performed by trimming (i.e., adjusting) a local oscillator (LO) frequency. In some embodiments, trimming an LO frequency is known as an LO trim. For example, an LO trim may be performed by adjusting a voltage-controlled oscillator (VCO) tuning voltage or changing a bias current of the VCO.

In some embodiments, the processing logic further receives an additional frame from the access point.

In some embodiments, the processing logic determines a CFO estimate for the additional frame received from the access point.

In some embodiments, the processing logic computes an updated final CFO estimate based on the CFO estimate. For example, the processing logic may re-compute an average CFO estimate value now including the newly received CFO estimate.

In some embodiments, the processing logic determines whether the updated final CFO estimate meets a criterion.

In some embodiments, the processing logic changes the first phase of the RF PLL to the second phase based on the final CFO estimate meeting the criterion or continues to receive additional frames from the access point based on the final CFO estimate not meeting the criterion.

FIG. 4 is a timing diagram illustrating radio frequency (RF) phased-locked loop (PLL) re-tune triggering for wireless LAN carrier frequency correction for uplink transmission, according to some embodiments.

In some embodiments, AP device 402 transmits on a medium (e.g., channel). Station device 404 determines that the N number of CFO estimates available 470 meets a criterion (e.g., N is greater than a threshold number 480). In response to determining that the criterion is met, station device 404 waits for the channel that AP 402 is transmitting on to become available. AP device 402 finishes transmitting, and station device 404, following an inter-frame space (IFS) 430, derements a random back-off counter every slot 432 during contention window 434. On winning the channel access (random back-off decrements to zero), station device 404 then sends CTS frame 463 to itself and blocks the medium (e.g., channel) to perform an LO trim and triggers the LO trim.

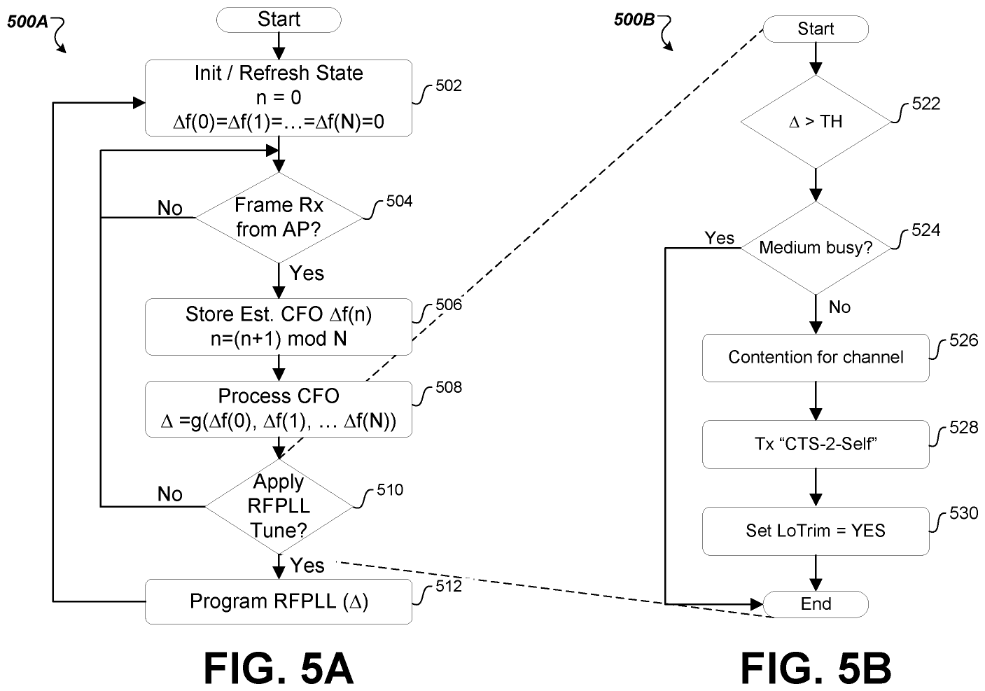

FIG. 5A is a flow diagram of a method of performing wireless LAN carrier frequency correction for uplink transmission, according to some embodiments.

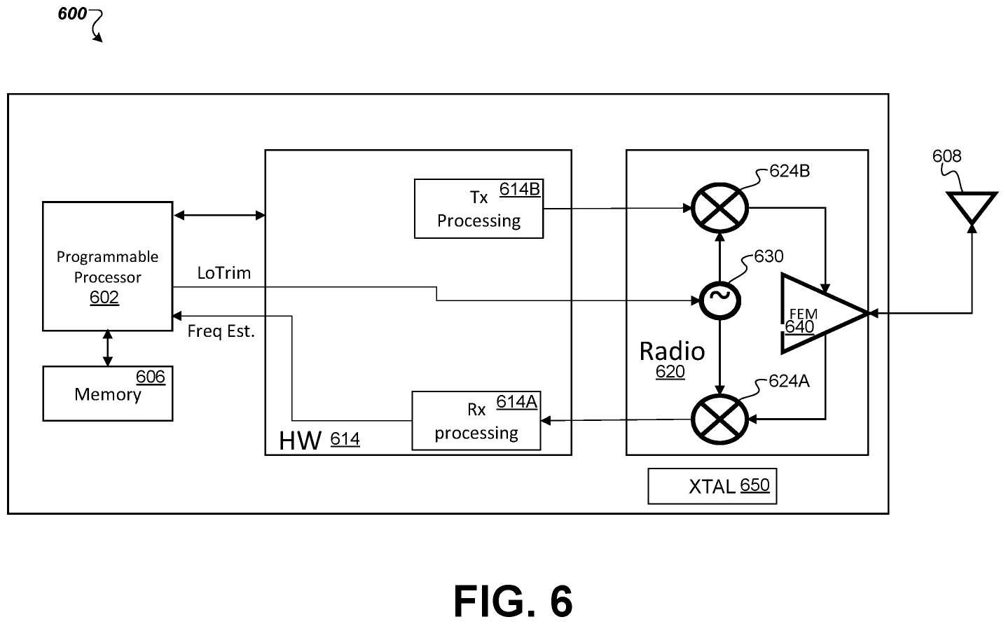

The method 500A can be performed by processing logic that can include hardware (e.g., processing device, circuitry, dedicated logic, programmable logic, microcode, hardware of a device, integrated circuit, etc.), a microcontroller (e.g., digital logic, programmed logic, firmware), or a combination thereof. In some embodiments, the method 500A is performed by control logic and/or hardware of one of the wireless devices 600, 700, and/or 800, 900 (FIGS. 6-9). Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 502, the processing logic initializes a number of CFO offset values to zero and/or starts a refresh state, causing the number of CFO offset values to be reset to zero and all values for CFO estimates 0 to N to be equal to zero.

At operation 504, the processing logic determines if a frame has been received from an AP device. If yes, the flow proceeds to operation 506. If no, the flow returns to operation 504.

At operation 506, the processing logic stores CFO estimates from the frame received from the AP. In some embodiments, the processing logic stores CFO estimates from the frame received from the AP in an array corresponding to an index “n” and increments the index “n”.

At operation 508, the processing logic processes the stored CFO estimates using function g(.). In some embodiments, the processing logic checks, based on some criteria, if the RF PLL re-tuning operation can be triggered based on the final CFO estimate.

At operation 510, the processing logic determines whether to apply the RF PLL tune. If yes, flow continues to operation 512. If no, flow returns to operation 504.

At operation 512, processing logic triggers the RF PLL re-tuning operation based on the final CFO estimate. Flow returns to operation 502, where the processing device refreshes the state (i.e., sets N number of CFO estimates to zero and the value of all CFO estimates to zero).

FIG. 5B is a flow diagram of a method of determining whether to trigger an RF PLL retuning for wireless LAN carrier frequency correction for uplink transmission, according to some embodiments. In some embodiments, FIG. 5B is a detailed flow of operation 510 of FIG. 5A.

The method 500B can be performed by processing logic that can include hardware (e.g., processing device, circuitry, dedicated logic, programmable logic, microcode, hardware of a device, integrated circuit, etc.), a microcontroller (e.g., digital logic, programmed logic, firmware), or a combination thereof. In some embodiments, the method 500B is performed by control logic and/or hardware of one of the wireless devices 600, 700, and/or 800, 900 (FIGS. 6-9). Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 522, the processing logic determines if a criterion has been met (e.g., the magnitude of the final CFO estimate greater than a threshold value).

At operation 524, the processing logic determines if the medium (e.g., channel) is busy. If yes, the flow ends (i.e., flow moves from operation 510 to operation 504 of FIG. 5A). If no, the flow continues to operation 526.

At operation 526, the processing logic contends for the medium (e.g., channel). In some embodiments, processing logic decrements a random back-off counter for every slot time while contending for the medium.

At operation 528, the processing logic causes a CTS-2-self frame to be sent (e.g., by a station device).

At operation 530, the processing logic sets LO trim to YES, meaning that an RF PLL re-tuning operation is to be performed by performing an LO trim (i.e., flow moves from operation 510 to operation 512 of FIG. 5A).

FIG. 6 is a block diagram of a wireless device to perform frequency estimation and trigger LO trim (RF PLL retuning) for wireless LAN carrier frequency correction for uplink transmission, according to some embodiments.

In some embodiments, the wireless device 600 is any of the wireless devices 118-132. In some embodiments, the wireless device 600 includes a programmable processor 602, a memory 606 (e.g., non-volatile and/or volatile memory), an antenna 608, hardware 614 including Rx processing hardware 614A and Tx processing hardware 614B, a radio 620 that includes RF circuitry, and an external oscillator 650 (e.g., an external crystal, or XTAL). In various embodiments, the radio 620 includes a demodulator 624A, a modulator 624B, an LO 630 (also referred to herein as the Tx LO), and a front-end module (hereinafter FEM 640) having one or more front-end modules operatively coupled to the antenna 608. In various embodiments, the radio 620 includes an analog-to-digital converter (ADC) 626 coupled to the demodulator 624A that is driven by the LO 630, and a digital-to-analog converter (DAC) 622 coupled to the modulator 624B that is driven by the LO 630.

In some embodiments, the programmable processor 602 executes instructions (e.g., computer code and/or firmware) to drive and provide parameters for the functionality of the hardware 614. In embodiments, the hardware 614 is coupled to the radio 620. In some embodiments, the LO 630 is implemented within an RF PLL of the RF circuitry, for example. In some embodiments, the LO 630 is integrated with the RF circuitry of the radio 620 and is either a resistive-capacitive (or R-C) oscillator or a real-time clock (RTC) oscillator. In some embodiments, the LO trim triggers the selection or de-selection of capacitors in a capacitor bank and/or resistors in a resistor bank in order to tune the Tx LO carrier frequency.

In some embodiments, an incoming signal or signals (e.g., containing management frames, control frames, data frames, and/or the like) are captured by the antenna 608 and the FEM 640 and passed to the demodulator 624A (e.g., a demodulator) to demodulate the received signal(s). In some embodiments, this demodulation extracts the original information-bearing signal(s) that include the management frames, control frames, data frames, etc. The Rx processing hardware 614A may then process the demodulated signals to obtain, among other information, an estimate of the CFO (e.g., CFO estimates) from the management frames, control frames, data frames, etc. In some embodiments, the Rx processing hardware 614A provides the CFO information to the programmable processor 602. In some embodiments, the programmable processor 602 is programmed to process the estimated CFOs (e.g., CFO estimates) to compute a final CFO estimate and to generate an LO trim value that will cause the LO 630 (or RF PLL that includes the LO 630) to shift in carrier frequency that compensates for the final estimated CFO (e.g., final CFO estimate).

Thus, in some embodiments, the transmission side of the wireless device 600 generates a transmission at a trimmed LO carrier frequency. For example, the Tx processing hardware 614B processes information for the upcoming transmission signal, which the modulator 624B then modulates and hands to the FEM 640. The modulator 624B uses a trimmed-off LO 630, and thus the TB-PDDU frame that is transmitted out of the FEM 640 and antenna 608 is based on the shifted carrier frequency of the trimmed LO 630 (e.g., trimmed Tx LO). In this way, the carrier leakage (which causes in-band and out-of-band distortions) is better dealt with by correcting the Tx LO (the LO620) of the wireless device 600 using the final CFO estimate to compensate for the CFO between the Rx LO (of the AP/BS device 116) and Tx LO.

Further, in some embodiments, the radio 620 comprises a radio frequency (RF) phase-locked loop (PLL) that includes the first LO. In these embodiments, the control logic (e.g., the programmable processor 602 in this embodiment) is configured to calculate an updated RF PLL frequency based on the CFO (e.g., final CFO estimate), trigger the RF PLL to operate at the updated RF PLL frequency in response to the LO trim, and after transmission of the protocol data unit frame, cause the RF PLL to operate at a default RF PLL frequency.

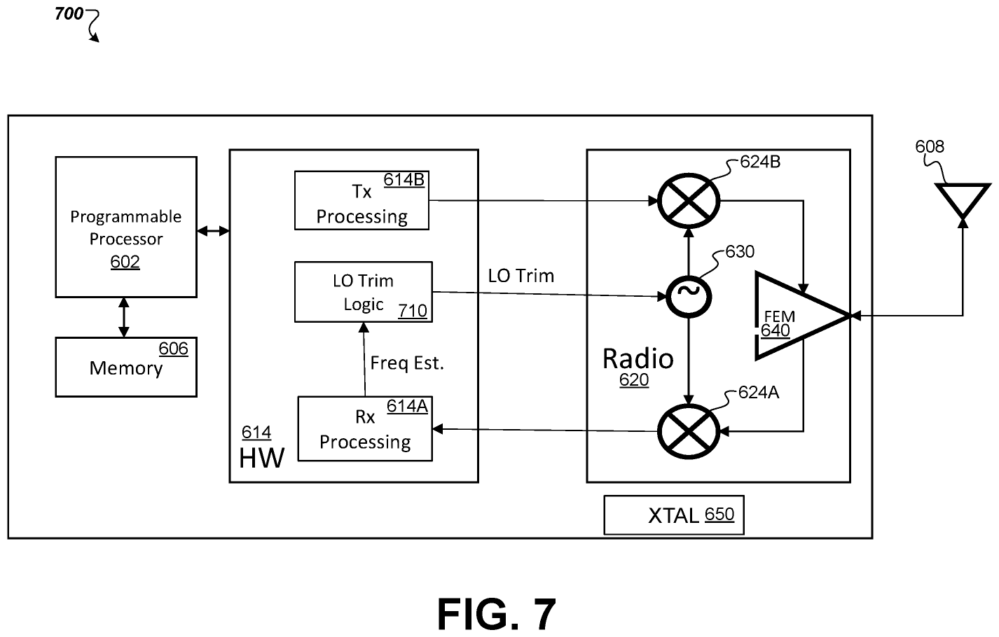

FIG. 7 is a block diagram of a wireless device employing hardware to perform frequency estimation and trigger LO trim (RF PLL retuning) for wireless LAN carrier frequency correction for uplink transmission, according to some embodiments.

In some embodiments, the wireless device 600 of FIG. 6 is modified so that instead of programmable processor 602 performing the LO trim, LO trim computation hardware 710 (which can be discrete hardware components, programmed hardware components, or a combination thereof) is included within the hardware 614 provided on the wireless device 700. In this embodiment, the LO trim computation hardware 710 calculates the LO trim value based on the final CFO estimate received from the Rx processing hardware 614A. In this embodiment, therefore, the LO trim computation hardware 710 provides the LO trim value to the LO 630 (or an RF PLL that includes the LO 630) to provide the shift in Rx LO carrier frequency to compensate for the estimated CFO (e.g., represented in the final CFO estimate).

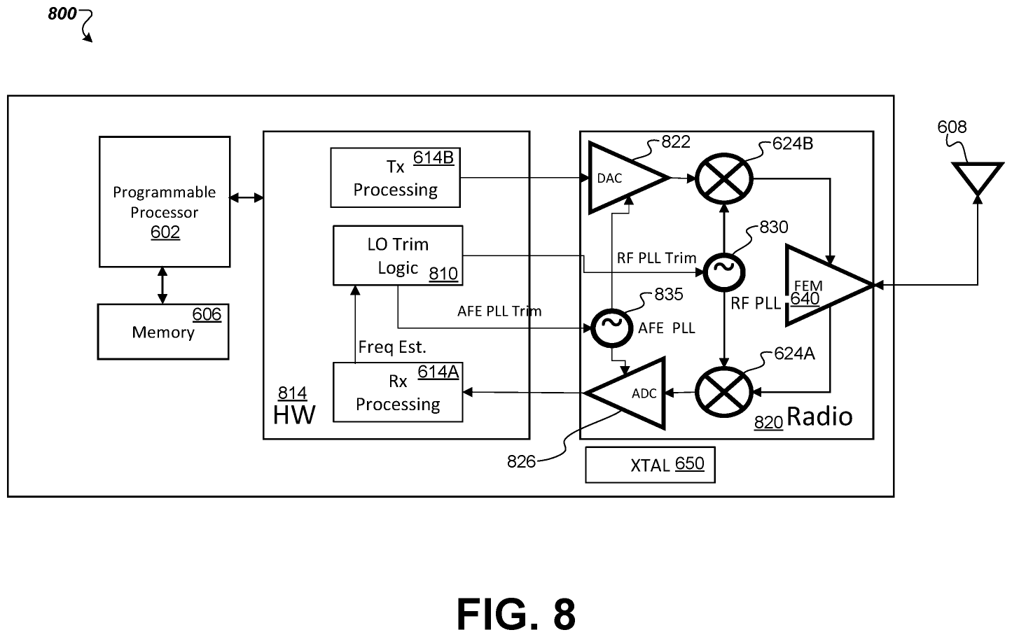

FIG. 8 is a block diagram of a wireless device employing hardware to perform both LO trim (RF PLL retuning) pre-correction and analog front end (AFE) PLL trimming for wireless LAN carrier frequency correction for uplink transmission, according to some embodiments.

In embodiments, the wireless device 800 of FIG. 8 expands on the wireless device 700 of FIG. 7 in implementations where the device includes different PLLs for generating clocks for the AFE and the RF separately. For example, in the embodiment of FIG. 8, a radio 820 of the wireless device 800 includes a radio frequency (RF) phase-locked loop (PLL) or RF PLL 830 (e.g., which can include an LO like the LO 630 from FIGS. 6-7), an analog-to-digital converter (ADC) 826 coupled to the demodulator 624A that is driven by the RF PLL 830, a digital-to-analog converter (DAC) 822 coupled to the modulator 624B that is driven by the RF PLL 830, and an analog front end PLL 835 (or RF PLL) configured to generate a clock to drive the ADC 826 and the DAC 822. In some embodiments, the receive (Rx) processing hardware 614A is coupled to the ADC 826 and the trim logic 810. In embodiments, the transmit (Tx) processing hardware 614B is coupled to the DAC 822.

In some embodiments, hardware 814 of the wireless device 800 includes LO trim logic 810 coupled to the RF PLL 830 and the analog front end PLL 835, where the clocking mechanism in the radio 820 has a separate PLL for the AFE clock from the RF PLL 830 that clocks the demodulator 624A and the modulator 624B. Thus, in these embodiments, the LO trim logic 810 is configured to trim both the analog front-end PLL 835 and the RF PLL 830 separately to provide ability for both carrier and sampling clock frequency tuning ability of the RF circuitry in the radio 820.

In some embodiments, therefore, the LO trim logic 810 is configured to determine, from each received frame of at least one received frame, a CFO estimate between a first carrier frequency of the RF PLL and a second carrier frequency of an LO of an access point (e.g., the AP/BS device 116) operating in a transmission mode. In some embodiments, the CFO estimates corresponding to each received frame are processed by LO trim logic 810 to determine a final CFO estimate. In some embodiments, the trim logic 810 further triggers, based on the final CFO estimate, a first trim of the RF PLL 830 to adjust the first carrier frequency to match, within a threshold tolerance, the second carrier frequency. In these embodiments, the LO trim logic 810 further triggers, based on the final CFO estimate, a second trim of the analog front-end PLL 835 to ensure both carrier and sampling clocks are aligned and support meeting the threshold tolerance. Thus, the radio 820 may be configured to transmit to the access point (e.g., the AP/BS device 116), a protocol data unit frame using the trimmed RF PLL. In some embodiments, the LO trim logic 810 can continuously trigger the first trim of the RF PLL 830 and the second trim of the analog front-end PLL 835 in response to detecting changes to the CFO estimate during transmission of multiple protocol data unit frames to the access point.

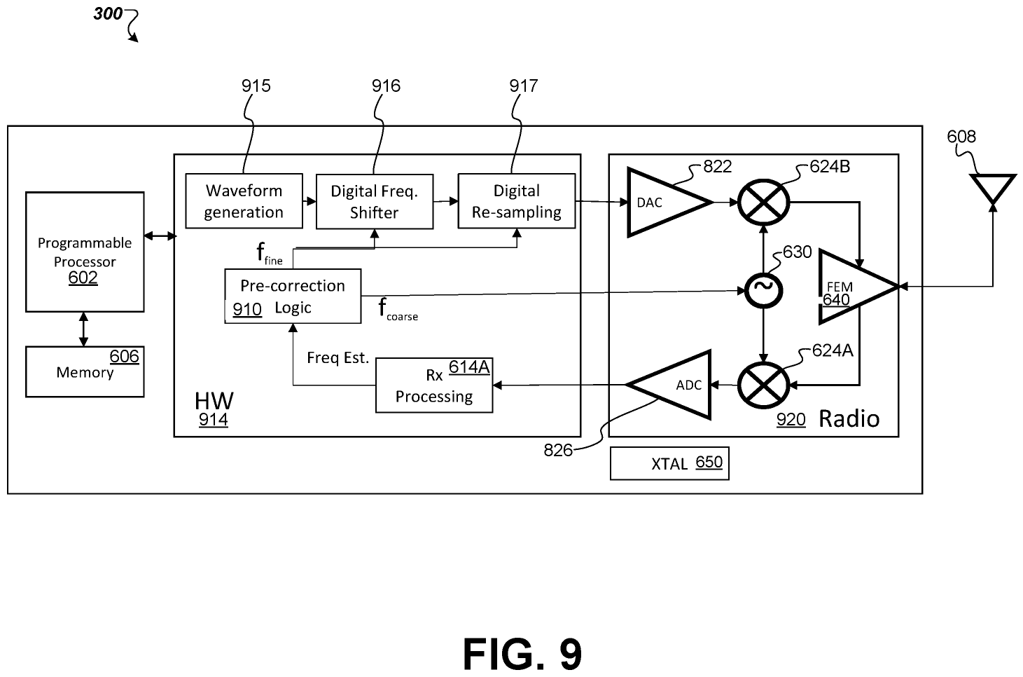

FIG. 9 is a block diagram of a wireless device 900 that performs LO trim (RF PLL retuning) pre-correction for coarse carrier frequency correction and digital pre-correction for fine carrier frequency for wireless LAN carrier frequency correction for uplink transmission, according to various embodiments.

In an extension to the embodiments of FIG. 8, the wireless device 900 employs a pre-correction to the final CFO estimate that is performed both through an LO trim for a coarse correction and in digital for a fine correction, enabling a wider range of potential frequency modifications to at least meet the stringent standard levels for EVM, UTE, and CFO. For example, this coarse/fine pre-correction approach may be implemented where the RF PLL accuracy is not sufficient to meet the specification of the standard requirements.

With reference to FIG. 9, the wireless device 900 includes hardware 914 with pre-correction logic 910 coupled between the Rx processing hardware 614A, the LO 630 (or RF PLL), and digital pre-correction components, which are also included in the hardware 914. In at least some embodiments, the pre-correction logic 910 is configured to determine that the LO trim (e.g., calculated as per FIG. 3) is insufficient to satisfy a target residual CFO value when transmitting to the AP/BS device 116. In some embodiments, the pre-correction logic 910 calculates a digital pre-correction offset required to satisfy the target residual CFO value and causes digital up-conversion, using the digital pre-correction offset, of a waveform driving digital processing of the protocol data unit frame.

More specifically, in at least some embodiments, the digital pre-correction components include a waveform generator 915 to generate a digital frame (e.g. TB-PPDU), a digital up-converter 916, and a digital re-sampler 917 that are coupled together in a string, the latter of which is coupled to the DAC 822. In these embodiments, the pre-correction logic 910 is configured to determine, based on a CFO estimate (e.g., CFO estimate and/or final CFO estimate), a coarse LO trim value (f_{coarse}), which the pre-correction logic 910 uses to adjust (trim) the LO 630 or RF PLL. Because that coarse trim may not be sufficient to meet the stringent requirement related to CFO of the IEEE standard, the pre-correction logic 910 may be configured to determine a set of digital parameters with which to update the digital up-conversion of the digital up-converter 916 and/or resampling of the digital re-sampler 917. In this way, the pre-correction logic 910 may trigger the digital pre-correction components in a further, fine digital pre-correction that impacts the signal sent through the DAC 822 for incorporation into the protocol data unit frame transmitted by a radio 920.

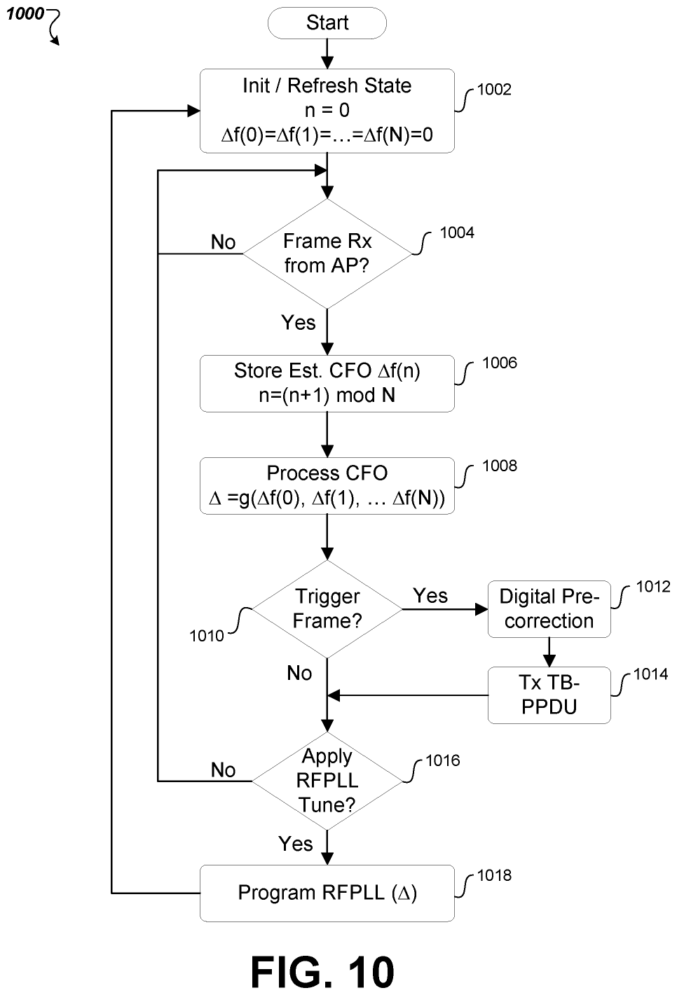

FIG. 10 is a flow diagram of a method 1000 of performing LO trim (RF PLL retuning) pre-correction for coarse carrier frequency correction and digital pre-correction for fine carrier frequency correction for wireless LAN carrier frequency correction for uplink transmission, according to various embodiments. In some embodiments, method 1000 ensures that the LO of a device will be synced by performing LO trim for non-triggered frames and digital pre-correction for triggered frames to correct for the residual offset that remains after LO trim.

The method 1000 can be performed by processing logic that can include hardware (e.g., processing device, circuitry, dedicated logic, programmable logic, microcode, hardware of a device, integrated circuit, etc.), a microcontroller (e.g., digital logic, programmed logic, firmware), or a combination thereof. In some embodiments, the method 1000 is performed by control logic and/or hardware, e.g., the pre-correction logic 910 of FIG. 9. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 1002, the processing logic initializes a number of CFO offset values to zero and/or starts a refresh state, causing the number of CFO offset values to be reset to zero and all values for CFO estimates 0 to N to be equal to zero.

At operation 1004, the processing logic determines if a frame has been received from an AP device. If yes, the flow proceeds to operation 1006. If no, the flow returns to operation 1004.

At operation 1006, the processing logic stores CFO estimates from all frames received from the AP.

At operation 1008, the processing logic processes the stored CFO estimates using function g(.). In some embodiments, the processing logic checks, based on some criteria, if the RF PLL re-tuning operation can be triggered based on the final CFO estimate.

At operation 1010, the processing logic determines if a trigger frame has been received (e.g., by station device). If no, the flow continues to operation 1016. If yes, the flow continues to operation 1012.

At operation 1012, the processing logic performs the digital pre-correction for the triggered frame to correct for the residual offset that remains after the last LO trim.

At operation 1014, the processing logic transmits a TB-PPDU frame (e.g., TB-PPDU 218 of FIG. 2).

At operation 1016, the processing logic determines whether to apply the RF PLL tunc. If yes, flow continues to operation 1018. If no, flow returns to operation 1004.

At operation 1018, processing logic triggers the RF PLL re-tuning operation based on the final CFO estimate. Flow returns to operation 1002, where the processing device refreshes the state (i.e., sets N number of CFO estimates to zero and the value of all CFO estimates to zero).

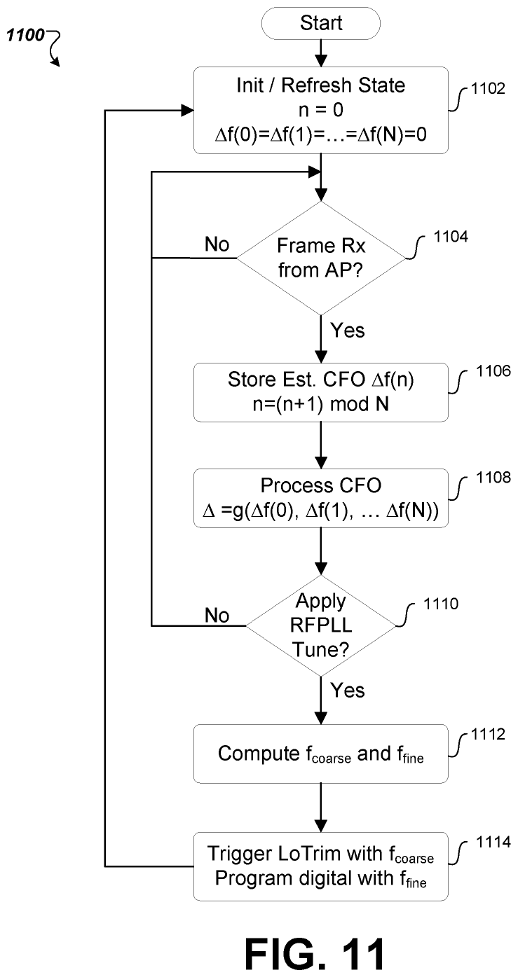

FIG. 11 is a flow diagram of a method of performing wireless LAN carrier frequency correction for uplink transmission, according to some embodiments. In some embodiment, a frequency estimate (CFO estimate) is divided into coarse and fine offsets. The coarse estimate may be used by LO trim, and the fine estimate may be used by digital pre-correction logic.

The method 1100 can be performed by processing logic that can include hardware (e.g., processing device, circuitry, dedicated logic, programmable logic, microcode, hardware of a device, integrated circuit, etc.), a microcontroller (e.g., digital logic, programmed logic, firmware), or a combination thereof. In some embodiments, the method 1100 is performed by control logic and/or hardware, e.g., the pre-correction logic 910 of FIG. 9. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 1102, the processing logic initializes a number of CFO offset values to zero and/or starts a refresh state, causing the number of CFO offset values to be reset to zero and all values for CFO estimates 0 to N equal to zero.

At operation 1104, the processing logic determines if a frame has been received from an AP device. If yes, the flow proceeds to operation 1106. If no, the flow returns to operation 1104.

At operation 1106, the processing logic stores CFO estimates from all frames received from the AP.

At operation 1108, the processing logic processes the stored CFO estimates using function g(.). In some embodiments, the processing logic checks, based on some criteria, if the RF PLL re-tuning operation can be triggered based on the final CFO estimate.

At operation 1110, the processing logic determines whether to apply the RF PLL tune. If yes, flow continues to operation 1112. If no, flow returns to operation 1104.

At operation 1112, the processing logic computes f_{coarse} CFO offset and f_{fine} CFO offset.

At operation 1114, the processing logic triggers the LO trim with the f_{coarse} CFO offset and programs the digital pre-correction with the f_{fine} CFO offset. Flow then returns to operation 1102, where the processing device refreshes the state (i.e., sets N number of CFO estimates to zero and the value of all CFO estimates to zero).

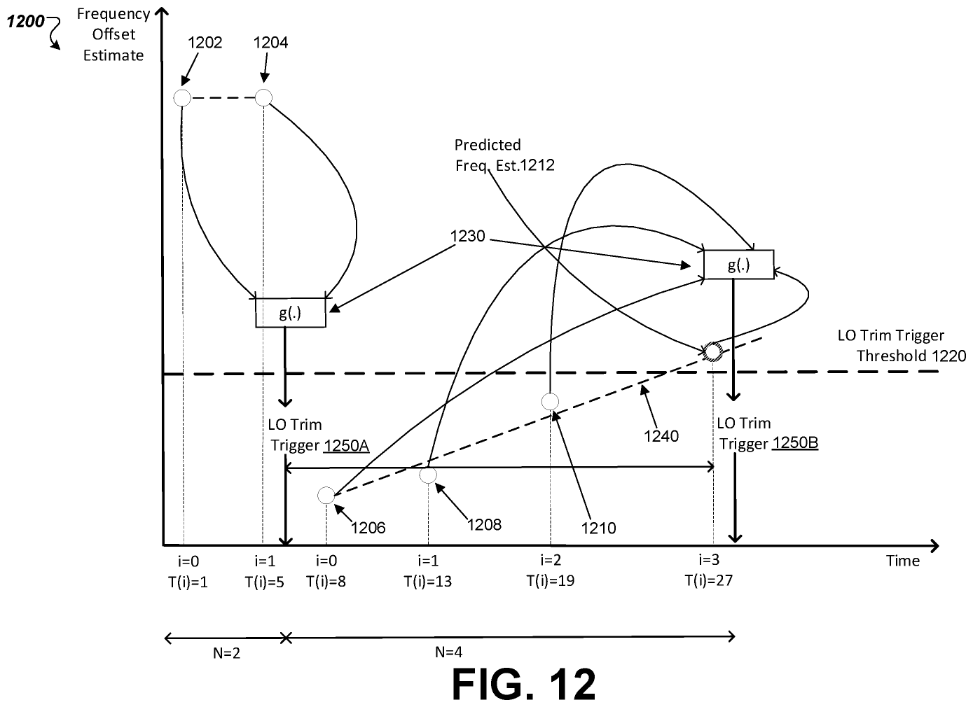

FIG. 12 is a simplified graph illustrating 1200 LO trim triggering for wireless LAN carrier frequency correction for uplink transmission, according to some embodiments.

In some embodiments, the y-axis may represent the magnitude of CFO estimates. The x-axis may represent time. In some embodiments, there may be N CFO estimates. In a first example, CFO estimates 1202 and 1204 may be greater than a LO trim trigger threshold 1220. Because CFO estimates 1202 and 1204 meet an LO trim trigger criterion, CFO estimates 1202 and 1204 are input into function g(.) 1230, and a final CFO estimate is calculated. An LO trim 1250A is triggered (e.g., RF PLL re-tuning operation triggered), and LO trim is triggered based on the final CFO estimate.

In a second example, CFO estimates 1206, 1208, and 1210 are each less than LO trim trigger threshold 1220. However, a predicted CFO estimate 1212 is greater than LO trim trigger threshold 1220. In some embodiments, a predicted CFO estimate may be made using a trendline 1240. Trendline 1240 may be a product of regression analysis, cluster analysis, time series analysis, etc. Because predicted CFO estimate 1212 is greater than LO trim trigger threshold 1220 (i.e., meets an LO trim trigger criterion), CFO estimates 1206, 1208, 1210, and predicted CFO estimate 1212 are input into function g(.) 1230 and a final CFO estimate is calculated. An LO trim trigger 1250B is received (e.g., RF PLL re-tuning operation triggered), and LO trim is triggered based on the final CFO estimate.

It will be apparent to one skilled in the art that at least some embodiments may be practiced without these specific details. In other instances, well-known components, elements, or methods are not described in detail or are presented in a simple block diagram format in order to avoid unnecessarily obscuring the subject matter described herein. Thus, the specific details set forth hereinafter are merely exemplary. Particular implementations may vary from these exemplary details and still be contemplated to be within the spirit and scope of the present embodiments.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “receiving,” “determining,” “computing,” “changing,” “calculating,” “continuing,” “adjusting,” or the like, refer to the actions and processes of a computing system, or similar electronic computing device, that manipulates and transforms data represented as physical (e.g., electronic) quantities within the computing system's registers and memories into other data similarly represented as physical quantities within the computing system memories or registers or other such information storage, transmission or display devices. Also, the terms “first,” “second,” “third,” “fourth,” etc., as used herein, are meant as labels to distinguish among different elements and cannot have an ordinal meaning according to their numerical designation.

Reference in the description to “an embodiment,” “one embodiment,” “an example embodiment,” “some embodiments,” and “various embodiments” means that a particular feature, structure, step, operation, or characteristic described in connection with the embodiment(s) is included in at least one embodiment. Further, the appearances of the phrases “an embodiment,” “one embodiment,” “an example embodiment,” “some embodiments,” and “various embodiments” in various places in the description do not necessarily all refer to the same embodiment(s).

The description includes references to the accompanying drawings, which form a part of the detailed description. The drawings show illustrations in accordance with exemplary embodiments. These embodiments, which may also be referred to herein as “examples,” are described in enough detail to enable those skilled in the art to practice the embodiments of the claimed subject matter described herein. The embodiments may be combined, other embodiments may be utilized, or structural, logical, and electrical changes may be made without departing from the scope and spirit of the claimed subject matter. It should be understood that the embodiments described herein are not intended to limit the scope of the subject matter but rather to enable one skilled in the art to practice, make, and/or use the subject matter.

The description includes references to the accompanying drawings, which form a part of the detailed description. The drawings show illustrations in accordance with exemplary embodiments. These embodiments, which may also be referred to herein as “examples,” are described in enough detail to enable those skilled in the art to practice the embodiments of the claimed subject matter described herein. The embodiments may be combined, other embodiments may be utilized, or structural, logical, and electrical changes may be made without departing from the scope and spirit of the claimed subject matter. It should be understood that the embodiments described herein are not intended to limit the scope of the subject matter but rather to enable one skilled in the art to practice, make, and/or use the subject matter.

Certain embodiments may be implemented by firmware instructions stored on a non-transitory computer-readable medium, e.g., such as volatile memory and/or non-volatile memory. These instructions may be used to program and/or configure one or more devices that include processors (e.g., CPUs) or equivalents thereof (e.g., such as processing cores, processing engines, microcontrollers, and the like) . . . . The non-transitory computer-readable storage medium may include, but is not limited to, electromagnetic storage medium, read-only memory (ROM), random-access memory (RAM), erasable programmable memory (e.g., EPROM and EEPROM), flash memory, or another now-known or later-developed non-transitory type of medium that is suitable for storing information.

Although the operations of the circuit(s) and block(s) herein are shown and described in a particular order, in some embodiments, the order of the operations of each circuit/block may be altered so that certain operations may be performed in an inverse order or so that certain operation may be performed, at least in part, concurrently and/or in parallel with other operations. In other embodiments, instructions or sub-operations of distinct operations may be performed in an intermittent and/or alternating manner.

In the foregoing specification, the disclosure has been described with reference to specific exemplary embodiments thereof. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense.

What is claimed is:

1. A method comprising:
receiving a plurality of frames from an access point;
determining a carrier frequency offset (CFO) estimate for each of the plurality of frames received from the access point;
computing a final CFO estimate based on the CFO estimates; and
changing, based on the final CFO estimate, a first phase of a radio frequency phase-locked loop (RF PLL) to a second phase.

2. The method of claim 1, further comprising determining whether the final CFO estimate meets a criterion, wherein the changing the first phase of the RF PLL to the second phase is based on the final CFO estimate meeting the criterion.

3. The method of claim 2, wherein meeting the criterion comprises determining that a number of CFO estimates is equal to a threshold number of CFO estimates.

4. The method of claim 3, further comprising:
determining a magnitude of at least one of the CFO estimates; and
changing the threshold number of CFO estimates from a first number to a second number responsive to the magnitude of the at least one of the CFO estimates meeting a threshold magnitude.

5. The method of claim 1, wherein the computing the final CFO estimate based on the CFO estimates comprises calculating at least one of an average, weighted average, moving average, or mean.

6. The method of claim 1, further comprising:
receiving an additional frame from the access point;
determining a CFO estimate for the additional frame received from the access point;
computing an updated final CFO estimate based on the CFO estimate;
determining whether the updated final CFO estimate meets a criterion; and
changing the first phase of the RF PLL to the second phase based on the final CFO estimate meeting the criterion or continuing to receive additional frames from the access point based on the final CFO estimate not meeting the criterion.

7. An apparatus comprising:
radio frequency (RF) circuitry comprising an RF phase-locked loop (PLL), wherein the RF circuitry is to receive a plurality of frames from an access point while the RF PLL operates at a first phase; and
a processing device coupled to the RF PLL, wherein the processing device is to:
determine a carrier frequency offset (CFO) estimate for each of the plurality of frames received from the access point;
compute a final CFO estimate based on the CFO estimates; and
change the RF PLL from the first phase to a second phase based on the final CFO estimate.

8. The apparatus of claim 7, wherein the processing device is further to determine whether the final CFO estimate meets a criterion, wherein the changing the first phase of the RF PLL to the second phase is based on the final CFO estimate meeting the criterion.

9. The apparatus of claim 8, wherein meeting the criterion comprises determining that a number of CFO estimates is equal to a threshold number of CFO estimates, wherein the threshold number of CFO estimates is based on magnitudes of the CFO estimates.

10. The apparatus of claim 7, wherein the computing the final CFO estimate based on the CFO estimates comprises calculating at least one of an average, weighted average, moving average, or mean.

11. The apparatus of claim 7, wherein the processing device is further to:
receive an additional frame from the access point;
determine a CFO estimate for the additional frame received from the access point;
compute an updated final CFO estimate based on the CFO estimate;
determine whether the updated final CFO estimate meets a criterion; and
change the first phase of the RF PLL to the second phase based on the final CFO estimate meeting the criterion or continue to receive additional frames from the access point based on the final CFO estimate not meeting the criterion.

12. The apparatus of claim 7, wherein the processing device comprises a state machine, wherein the state machine is to:
determine a CFO estimate for each of the plurality of frames received from the access point;
compute a final CFO estimate based on the CFO estimates; and
change the RF PLL from the first phase to a second phase based on the final CFO estimate.

13. The apparatus of claim 7, wherein the processing device comprises firmware, wherein the firmware is to:
determine a carrier frequency offset (CFO) estimate for each of the plurality of frames received from the access point;
compute a final CFO estimate based on the CFO estimates; and
change the RF PLL from the first phase to a second phase based on the final CFO estimate.

14. A system comprising:
a first circuit, wherein the first circuit comprises a radio frequency (RF) phase-locked loop (PLL), and the first circuit is to receive a plurality of frames from an access point; and
a second circuit, wherein the second circuit is to:
determine a carrier frequency offset (CFO) estimate for each of the plurality of frames received from the access point;
compute a final CFO estimate based on the CFO estimates; and
change the RF PLL from a first phase to a second phase based on the final CFO estimate.

15. The system of claim 14, wherein the second circuit is further to determine whether the final CFO estimate meets a criterion, wherein the changing the first phase of the RF PLL to the second phase is based on the final CFO estimate meeting the criterion.

16. The system of claim 15, wherein meeting the criterion comprises determining that a number of CFO estimates is equal to a threshold number of CFO estimates, wherein the threshold number of CFO estimates is based on magnitudes of the CFO estimates.

17. The system of claim 14, wherein the computing the final CFO estimate comprises calculating at least one of an average, weighted average, moving average, or mean.

18. The system of claim 14, the second circuit further to:
receive an additional frame from the access point;
determine a CFO estimate for the additional frame received from the access point;
compute an updated final CFO estimate based on the CFO estimate;
determine whether the updated final CFO estimate meets a criterion; and
change the first phase of the RF PLL to the second phase based on the final CFO estimate meeting the criterion or continue to receive additional frames from the access point based on the final CFO estimate not meeting the criterion.

19. The system of claim 14, wherein the second circuit comprises a state machine, wherein the state machine is to:
determine a CFO estimate for each of the plurality of frames received from the access point;
compute a final CFO estimate based on the CFO estimates; and
change the RF PLL from the first phase to a second phase based on the final CFO estimate.

20. The system of claim 14, wherein the second circuit comprises firmware, wherein the firmware is to:
determine a CFO estimate for each of the plurality of frames received from the access point;
compute a final CFO estimate based on the CFO estimates; and
change the RF PLL from the first phase to a second phase based on the final CFO estimate.
